(19) United States
(12) Patent Application Publication
(10) Pub. No.: US 2017/0293629 A1
(43) Pub. Date: Oct. 12, 2017

(54) MERGING MULTIPLE GROUPS OF RECORDS CONTAINING DUPLICATES

(71) Applicant: salesforce.com, inc., San Francisco, CA (US)

(72) Inventors: Dai Duong DOAN, Alameda, CA (US); Chenghung KER, Burlingame, CA (US); Parth VAISHNAV, Cupertino, CA (US); Danil DVINOV, San Francisco, CA (US)

(21) Appl. No.: 15/094,232

(22) Filed: Apr. 8, 2016

(51) Int. Cl. G06F 17/30

(52) U.S. Cl. CPC G06F 17/30156; G06F 17/30371; G06F 17/30489

(57) ABSTRACT

The method includes generating a first graphical representation of a first group of records, including a root node associated with a first representative record of a duplicate record in the first group, the first graphical representation associated with a rank corresponding to a height of the first graphical representation. The method further includes forming a map to reflect the first graphical representation and first representative record. A second graphical representation of a second group of records is generated including a root node associated with a second representative record in the second group. The method compares each of the records in the second group of records with the map to determine if there is a sharing of a duplicate record in the second group with the first group. The first and second graphical representations are merged based on the second group of records sharing a duplicate record with the first group.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves copyright rights whatsoever.

### TECHNICAL FIELD

The present disclosure relates generally to data processing and more specifically relates to processing groups of records containing duplicate records.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Database systems may include databases that have millions of records. To maintain the efficiency and integrity of the databases, searches may be performed to identify and remove duplicate records. Comparison of records against all the other records one-by-one to determine duplication may be significantly time consuming and computing intensive. As such, database designers continuously try to develop techniques that can improve the performance of the database by identifying related or duplicate records.

### BRIEF SUMMARY

For some embodiments, methods and systems for merging multiple groups of records containing duplicate records in a database system may include generating, by the database system, a first graphical representation of a first group of records, the first graphical representation including a root node associated with a duplicate record in the first group and identified as a first representative record, the first graphical representation associated with a rank corresponding to a height of the first graphical representation. The method further includes forming, by the database system, a map to reflect the first graphical representation including the first representative record; generating, by the database system, a second graphical representation of a second group of records, the second graphical representation including a root node associated with a duplicate record in the second group and identified as a second representative record; comparing each of the records in the second group of records with the map to determine if there is a sharing of a duplicate record in the second group of records with the first group of records; and merging the second graphical representation with the first graphical representation based on the second group of records sharing a duplicate record with the first group of records. Other aspects and advantages of the present invention can be seen on review of the drawings, the detailed description and the claims, which follow.

### BRIEF DESCRIPTION OF THE DRAWINGS

The included drawings are for illustrative purposes and serve only to provide examples of possible structures and process steps for the disclosed techniques. These drawings in no way limit any changes in form and detail that may be made to embodiments by one skilled in the art without departing from the spirit and scope of the disclosure.

FIG. 1 shows a diagram of an example computing system that may be used with some embodiments.

FIG. 2 shows a diagram of an example network environment that may be used with some embodiments.

FIG. 3 shows an example of a merging module, in accordance with some embodiments.

FIGS. 4A-4B show examples of graphical representation, in accordance with some embodiments.

FIG. 5A shows an example of merging two graphical representations, in accordance with some embodiments.

FIGS. 5B-5C shows examples of graphical representation associated with a group of records to be processed, in accordance with some embodiments.

FIG. 6 shows an example of merging three graphical representations, in accordance with some embodiments.

FIG. 7 shows a flowchart of an example process for merging two groups of records using graphical representations, in accordance with some embodiments.

FIG. 8A shows a system diagram illustrating architectural components of an applicable environment, in accordance with some embodiments.

FIG. 8B shows a system diagram further illustrating architectural components of an applicable environment, in accordance with some embodiments.

FIG. 9 shows a system diagram illustrating the architecture of a multitenant database environment, in accordance with some embodiments.

FIG. 10 shows a system diagram further illustrating the architecture of a multi-tenant database environment, in accordance with some embodiments.

### DETAILED DESCRIPTION

Applications of systems and methods for merging groups of records containing duplicate records using graphical representation will be described with reference to example embodiments. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific embodiments. Although these embodiments are described in sufficient detail to enable one skilled in the art to practice the disclosure, it is understood that these examples are not limiting, such that other embodiments may be used and changes may be made without departing from the spirit and scope of the disclosure.

As used herein, the term “multi-tenant database system” refers to those systems in which various elements of hardware and software of the database system may be shared by one or more customers. For example, a given application server may simultaneously process requests for a great number of customers, and a given database table may store rows for a potentially much greater number of customers.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more embodiments may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

In general, businesses use a CRM (Customer Relationship Management) system (also referred to as a database system or system) to manage business relationships and information associated with the business relationship. For example, this may include customer and prospect contact information, accounts, leads, and opportunities in one central location. The information may be stored in a database as objects. For example, the CRM system may include “account” object, “contact” object and “opportunities” object.

The “account” object may include information about an organization or person (such as customers, competitors, and partners) involved with a particular business. The “contact” object may include contact information, where each contact may be an individual associated with an “account”. The “opportunities” object includes information about a sale or a pending deal. Each object may be associated with fields. For example, the “accounts” object may include fields such as “company”, “zip”, “phone number”, “email address”, etc. The “contact” object may include fields such as “first name”, “last name”, “phone number”, “accountID”, etc. The “accountID” field of the “contact” object may be the ID of the account that is the parent of the contact. The “opportunity” object may include fields such as “amount”, “accountID”, etc. The “accountID” field of the “opportunity” object may be the ID of the account that is associated with the opportunity. Each field may be associated with a field value. For example, a field value for the “zip” field may be “94105”.

There may be millions of records (e.g., individual contacts) in an object (e.g., contact object). When a new contact is inserted into the contact object, a match rule (or matching rule) may be applied to identify duplicate contacts. A match rule may use criteria to determine how closely a field on a new or edited record matches the same field on an existing record, and, ultimately, whether the two records match. A match key may be used by a match rule to quickly return a list of possible duplicates. The match key may be based on one or more fields. For example, a match key that is based on a “company” field and a “zip” field in an “accounts” object may be “company (2,6) zip (1,3)” with the numbers inside the brackets referring to number of tokens and number of characters per token.

Before the match keys are applied to any objects, the field values of those objects may be normalized. For example, if the object includes the field “company”, then the normalization for the field “company” may include expanding the acronyms, having the first letter of each word be in lowercases, removing the suffices such as “Corporation”, “Incorporated”, “Inc”, “Limited”, “Ltd.”, etc., and removing the stop words such as “and”, “the”, “of”. Using this normalization example, the field value “Intel Corp.” is normalized to become “intel”, and the field value “IBM” is normalized to become “international business machine”.

After the field values are normalized, some standard or pre-defined match keys are automatically applied when the match rule is activated. An example of a pre-defined match key is “company (2, 6) zip (1, 3)” that is applied to the “account” object. For example, if the company name is “salesforce.com”, then applying the first portion “company (2, 6)” of the match key results in the string “salesf”, and if the company zip code is “94105-5188”, then applying the second portion “zip (1, 3)” of the match key results in the string “941”. The resulting key is therefore “salesf941”. The process of applying the standard match keys may be referred to as indexing.

When the match rule is activated, the match key is automatically applied to all existing records so that when the match rule runs, the database system can look for duplicate candidates among records with the same key. For example, when the above example match key is applied to the “company” and “zip” fields, the key “sales941” is generated to match duplicate records having the same value in the “company” and “zip” fields. Using the match key to identify duplicate candidates can prevent users from saving duplicate records based on the value of one or more fields.

Using match rules to identify duplicate candidates may be applicable when adding a new record or an edited record into an object to determine how closely a field on the new or edited record matches the same field on an existing record and whether the two records match. However, this approach may not be applicable when an organization has millions of records that need to be processed to remove duplicate records (also referred to as de-duplication or de-dupe). The identification of the duplicate records can be challenging and may significantly affect the performance of the CRM system.

During the de-duplication process, if a record A is determined to be a duplicate of two other records B and C, the de-duplication process may store the three records in a first group of records as {A, B, C}. When a record D is determined to be a duplicate of the records C and E, the de-duplication process may include the record D in the first group of records as {A, B, C, D}. In addition, the de-duplication process may also store the records D, C and E in a second group of records as {D, C, E}. Storing both the first group of records {A, B, C, D} and the second group of records {C, D, E} may waste storage space because the records C and D appear in both the first and second groups of records. Further, when these two groups of records are presented to a user (e.g., an administrator responsible for de-duplication), the user may prefer to receive one merged group such as {A, B, C, D, E} rather than two separate groups of {A, B, C, D} and {D, C, E}.

The disclosed embodiments may include systems and methods for merging multiple groups of records containing duplicate records associated with a database system and may include generating, by the database system, a first graphical representation of a first group of records, the first graphical representation including a root node associated with a duplicate record in the first group and identified as a first representative record, the first graphical representation associated with a rank corresponding to a height of the first graphical representation. The method further includes forming, by the database system, a map to reflect the first graphical representation including the first representative record; generating, by the database system, a second graphical representation of a second group of records, the second graphical representation including a root node associated with a duplicate record in the second group and identified as a second representative record; comparing each of the records in the second group of records with the map to determine if there is a sharing of a duplicate record in the second group of records with the first group of records; and merging the second graphical representation with the first graphical representation based on the second group of records sharing a duplicate record with the first group of records.

The disclosed embodiments may include an apparatus for merging multiple groups of records containing duplicate records and include one or more processors and a non-transitory computer readable medium storing a plurality of instructions, which when executed, cause the one or more processors to generate a first graphical representation of a first group of records, the first graphical representation including a root node associated with a duplicate record in the first group and identified as a first representative record, the first graphical representation associated with a rank corresponding to a height of the first graphical representation; form a map to reflect the first graphical representation including the first representative record; generate a second graphical representation of a second group of duplicated records, the second graphical representation including a root node associated with a duplicate record in the second group and identified as a second representative record; compare each of the records in the second group of records with the map to determine if there is a sharing of a duplicate record in the second group of records with the first group of records; and merge the second graphical representation with the first graphical representation based on the second group of records sharing a duplicate record with the first group of records.

The disclosed embodiments may include a computer program product comprising computer-readable program code to be executed by one or more processors when retrieved from a non-transitory computer-readable medium, the program code including instructions to generate, by the database system, a first graphical representation of a first group of records, the first graphical representation including a root node associated with a duplicate record in the first group and identified as a first representative record, the first graphical representation associated with a rank corresponding to a height of the first graphical representation; form a map to reflect the first graphical representation including the first representative record; generate, by the database system, a second graphical representation of a second group of records, the second graphical representation including a root node associated with a duplicate record in the second group and identified as a second representative record; compare each of the records in the second group of records with the map to determine if there is a sharing of a duplicate record in the second group of records with the first group of records; and merge the second graphical representation with the first graphical representation based on the second group of records sharing a duplicate record with the first group of records.

While one or more implementations and techniques are described with reference to an embodiment in which multiple groups of records containing duplicate records are merged using graphical representation and implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

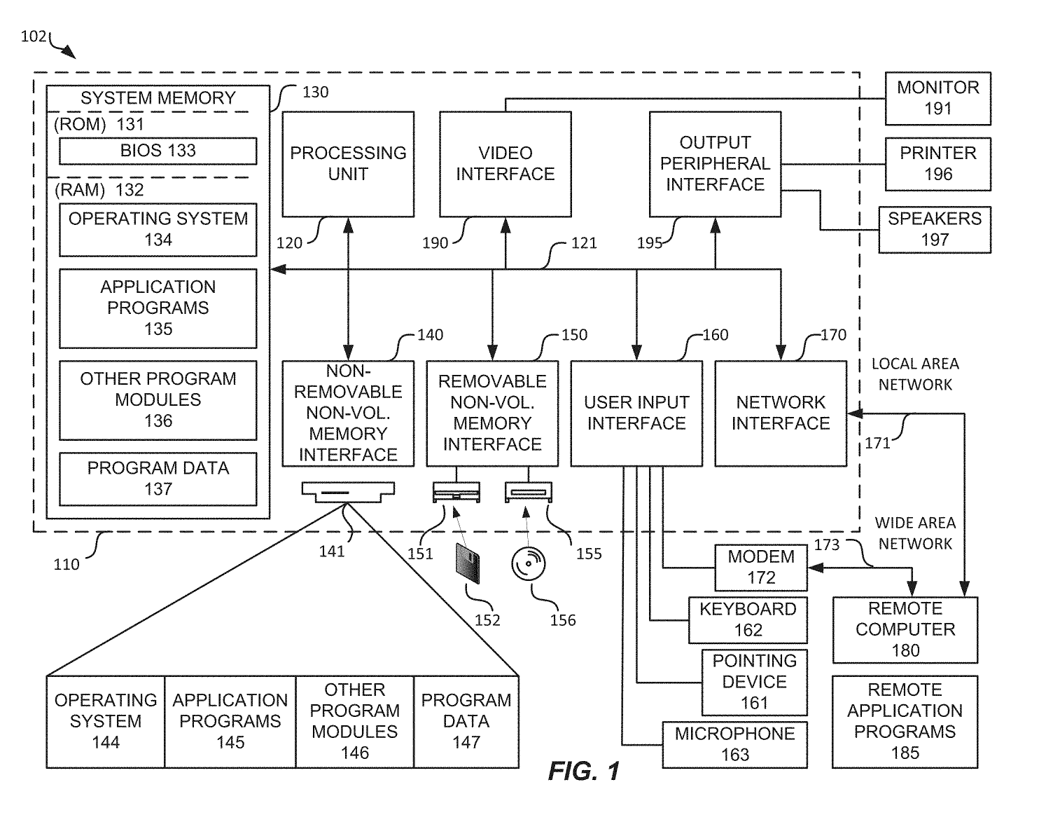

FIG. 1 is a diagram of an example computing system that may be used with some embodiments of the present invention. The computing system 102 may be used by a user such as a de-duplication administrator to merge multiple groups of records containing duplicate records in a multi-tenant database environment. For example, the multi-tenant database environment may be associated with the services provided by Salesforce.com®.

The computing system 102 is only one example of a suitable computing system, such as a mobile computing system, and is not intended to suggest any limitation as to the scope of use or functionality of the design. Neither should the computing system 102 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 102 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 1, the computing system 102 may include, but are not limited to, a processing unit 120 having one or more processing cores, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 102 typically includes a variety of computer readable media. Computer readable media can be any available media that can be accessed by computing system 102 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 102. Communication media typically embodies computer readable instructions, data structures, or program modules.

The system memory 130 may include computer storage media in the form of volatile and/or nonvolatile memory such as read only memory (ROM) 131 and random access memory (RAM) 132. A basic input/output system (BIOS) 133, containing the basic routines that help to transfer information between elements within computing system 102, such as during start-up, is typically stored in ROM 131. RAM 132 typically contains data and/or program modules that are immediately accessible to and/or presently being operated on by processing unit 120. By way of example, and not limitation, FIG. 1 also illustrates operating system 134, application programs 135, other program modules 136, and program data 137.

The computing system 102 may also include other removable/non-removable volatile/nonvolatile computer storage media. By way of example only, FIG. 1 also illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing system 102. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. The operating system 144, the application programs 145, the other program modules 146, and the program data 147 are given different numeric identification here to illustrate that, at a minimum, they are different copies.

A user may enter commands and information into the computing system 102 through input devices such as a keyboard 162, a microphone 163, and a pointing device 161, such as a mouse, trackball or touch pad or touch screen. Other input devices (not shown) may include a joystick, game pad, scanner, or the like. These and other input devices are often connected to the processing unit 120 through a user input interface 160 that is coupled with the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computing system 102 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing system 102. The logical connections depicted in

FIG. 1 includes a local area network (LAN) 171 and a wide area network (WAN) 173, but may also include other networks. Such networking environments are commonplace in offices, enterprise-wide computer networks, intranets and the Internet.

When used in a LAN networking environment, the computing system 102 may be connected to the LAN 171 through a network interface or adapter 170. When used in a WAN networking environment, the computing system 102 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computing system 102, or portions thereof, may be stored in a remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that some embodiments of the present invention may be carried out on a computing system such as that described with respect to FIG. 1. However, some embodiments of the present invention may be carried out on a server, a computer devoted to message handling, handheld devices, or on a distributed system in which different portions of the present design may be carried out on different parts of the distributed computing system.

Another device that may be coupled with the system bus 121 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 172 may employ a Wireless Application Protocol (WAP) to establish a wireless communication channel. The communication module 172 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

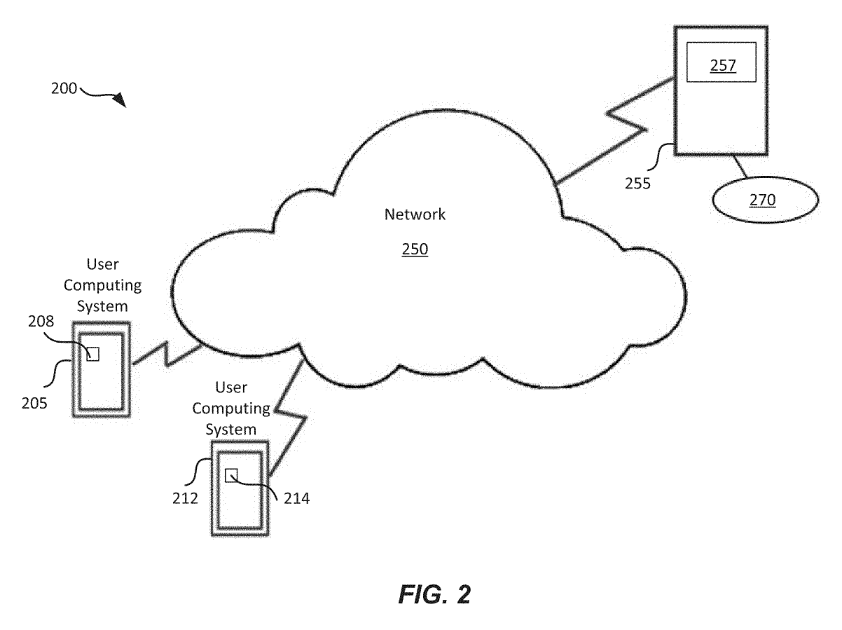

FIG. 2 shows a diagram of an example network environment that may be used with some embodiments of the present invention. Network environment 200 includes computing systems 205 and 212. One or more of the computing systems 205 and 212 may be a mobile computing system. The computing systems 205 and 212 may be connected to the network 250 via a cellular connection or via a Wi-Fi router (not shown). The network 250 may be the Internet. The computing systems 205 and 212 may be coupled with server computing system 255 via the network 250.

The computing systems 205 may include application module 208. A user may use the computing system 205 and the application module 208 to connect to and communicate with the server computing system 255 and log into application 257 (e.g., a Salesforce.com® application). For example, the user may log into the application 257 to initiate the process of graphically representing groups of records, identifying groups that share duplicate records, and merging them using the graphical representation. The server computing system 255 may be coupled with database 270. The server computing system 255 may be associated with an entity (e.g., Salesforce.com®).

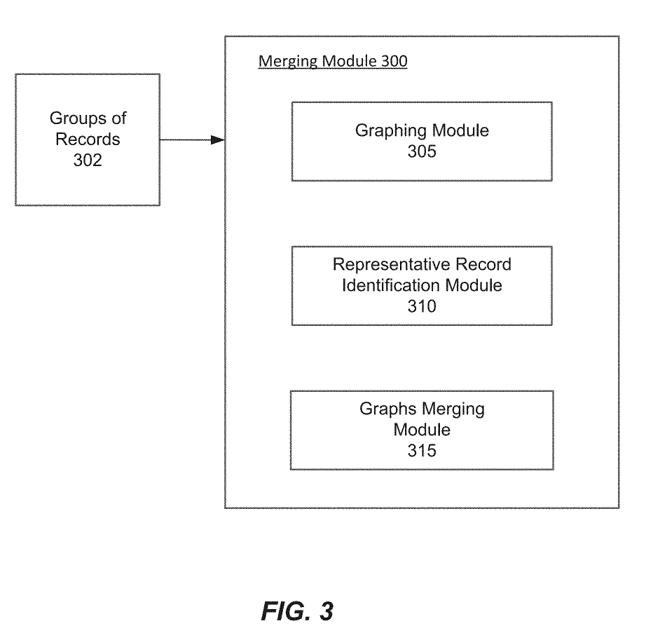

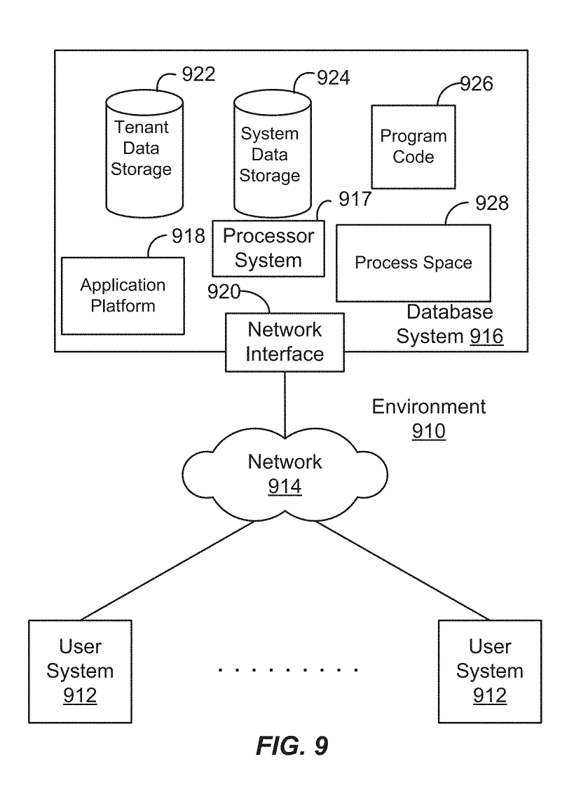

FIG. 3 shows an example of a merging module, in accordance with some embodiments. The merging module 300 may be associated with a computing system that is used by an administrator or a user who is responsible for removing duplicate records associated with a CRM system. The merging module 300 may receive and process the groups or sets of records 302. The groups of records 302 may have been generated by a de-duplication process. The groups of records 302 may be stored in a database such as database 270 shown in FIG. 2. The groups of records 302 may be associated with a web-based customer relationship management (CRM) database system 916 shown in FIG. 9. The merging module 300 may enable merging groups of records 302 into the same graphical representation.

The merging module 300 may include a graphing module 305 configured to generate a graphical representation of a group of records. The graphical representation may include a root node and one or more non-root nodes. The graphical representation may be associated with a rank which may represent its height. A record from a group of records may be selected as a representative record. The representative record may be associated with the root node of the graphical representation. For some embodiments, the graphing module 305 may be configured to enable any non-root node in the graphical representation to connect or point directly to the root node. This may enable the graphical representation to be traversed as if it is a flat graphical representation.

The merging module 300 may include a representative record identification module 310 configured to traverse a graphical representation to identify a representative record associated with a group of records. For example, given a duplicate record associated with a non-root node, the representative record identification module 310 may traverse the graphical representation to find its parent node and so on until the root node is reached.

The merging module 300 may include a graph merging module 315 configured to merge two graphical representations. For some embodiments, a graphical representation with fewer nodes may be merged to a graphical representation with more nodes. Merging may occur by making one graphical representation a branch of the other graphical representation with the root node of one graphical representation being a non-root node of the other graphical representation.

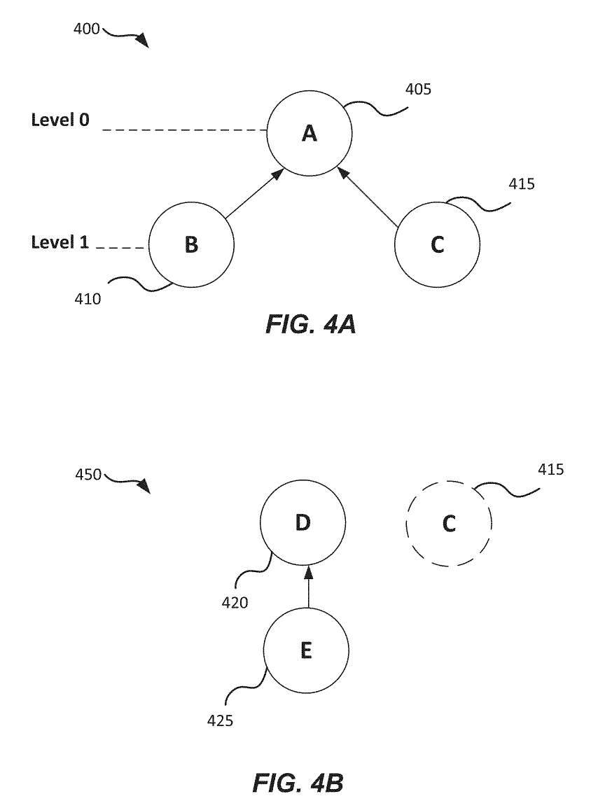

FIGS. 4A-4B show examples of graphical representation, in accordance with some embodiments. Graphical representation 400 is shown to include three nodes corresponding to three records A, B and C. The record A is the representative record and is associated with the root node 405. The records B and C are associated with the non-root nodes 410, 415. The root node 405 may be considered as being at level zero, while the non-root nodes 410, 415 may be considered as being at level one. For some embodiments, each graphical representation is associated with a rank corresponding to a highest level in that graphical representation. For example, the graphical representation 400 has a rank of one (1). The rank may be used to keep track of the size of the graphical representation. A map (referred to herein as map M) may be defined to keep track of the records in a graphical representation. For example, the map M corresponding to the graphical representation 400 may be defined in pairs as {A:A, B:A, C:A} where the first element of each pair representing the duplicate record and the second element representing the representative record associated with the root node.

When the merging module 300 process another group of records, each of the records may be compared against the map corresponding to the graphical representation 400. For example, when a group of records includes the records D, C and E, the merging module 300 may recognize that the record C in this group is already included in the map M. As such, the record C may be omitted from the group, leaving only the records D and E remaining. A graphical representation 450 of the group is shown in FIG. 4B with the record D being the representative record associated with the root node 420 and the record E associated with a non-root node 425. The node 415 in FIG. 4B is shown in dotted line to indicate that it is not part of the graphical representation 450 and to show that it is associated with the same record as the node 415 in FIG. 4A.

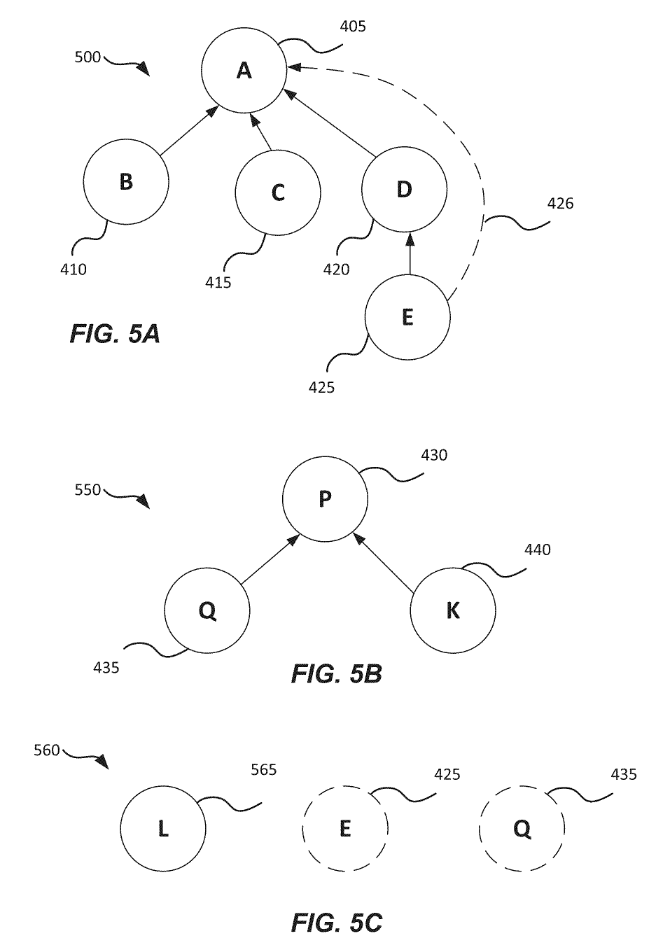

FIG. 5A shows an example of merging two graphical representations, in accordance with some embodiments. Graphical representation 500 may be generated by merging the graphical representation 400 and 450. The merging may occur by adding the graphical representation 450 as a branch to the graphical representation 400 at the at a non-root location. The root node 420 of the graphical representation 450 becomes a non-root node. In this example, the non-root location is at the same level as the level of the node 415 associated with the record C. The dotted line 426 is used to illustrate that a connection can be established between the non-root node 425 and the root node 405 for flat graph traversal even though the root node 405 is not an immediate parent of the non-root node 425. It may be noted that the graphical representation 500 has a rank of two (2) because the node 425 is positioned at a different level from the node 420. The map M may be updated to include the pairs {A:A, B:A, C:A, D:A, E:A} to reflect the records associated with the graphical representation 500.

FIG. 5B shows an example of a graphical representation associated with another group of records to be processed, in accordance with some embodiments. When the merging module 300 processes a group of records P, Q and K, each of the records in the group may be compared against the map M. Since none of the records P, Q and K matches with any record included in the map M, the graphical representation 550 may be generated to represent the three records P, Q and K. The record P is selected as the representative record and is associated with the root node 430, while the record Q is associated with the non-root node 435 and the record K is associated with a non-root node 440. Because there is no match, there is no merging of the graphical representation 500 and the graphical representation 550. The map M may be updated to include the pairs {A:A, B:A, C:A, D:A, E:A, P:P, Q:P, K:P} to reflect the records associated with both the graphical representation 500 and the graphical representation 550. It may be noted that graphical representation 550 may not be merged with the graphical representation 500 because they do not share any duplicated record. As such, the map M shows that there are two representative records A and P.

FIG. 5C shows an example of a graphical representation associated with another group of records to be processed, in accordance with some embodiments. When the merging module 300 processes a group of records E, Q and L, each of the records in the group may be compared against the map M. The merging module 300 may recognize that the record E in this group matches with the record E in the map corresponding to the graphical representation 500, and the record Q in this group matches with the record Q in the map corresponding to the graphical representation 550. Based on the matches, the records E and Q may be omitted from the group, leaving only the record L remaining as the only node 565 in the graphical representation 560. The nodes 425 and 435 in FIG. 5C are shown in dotted line to indicate that they are not part of the graphical representation 560 and to show that they are associated with the same records as the node 425 in FIG. 5A and the node 435 in FIG. 5B.

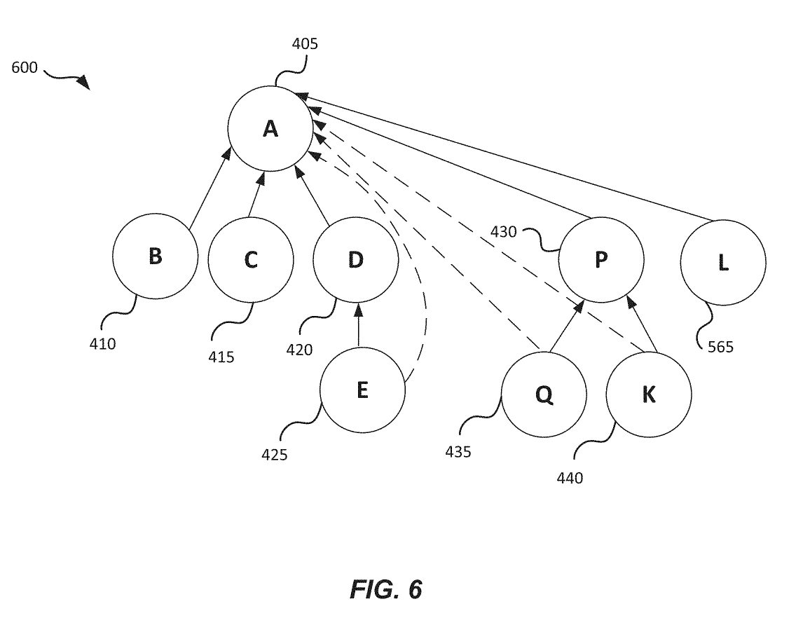

FIG. 6 shows an example of merging three graphical representations, in accordance with some embodiments. Since there is a match in the map M with respect to the records E and Q, the graphical representations 550 and 560 may be merged with the graphical representation 500. Graphical representation 600 includes the graphical representations 550 and 560 attached at the same level while retaining their own parent-child node structures. It may be noted that the merging occurs by attaching to the graphical representation 500 because it is a larger graphical representation with the most number of nodes. As a result, the representative record A remains as the root node in the graphical representation 600 and also serves as the representative record for the records P, Q, K and L. It may also be noted that the rank of the graphical representation 600 is two (2). The dotted lines between the records E, Q, K and the representative record A at the root node show a direct connection based on path compression. The map M may be updated to include the pairs to {A:A, B:A, C:A, D:A, E:A, P:A, Q:A, K:A, L:A} to reflect the resulting merged graphical representation 600.

The generation of the graphical representation with the examples in FIGS. 4A, 4B, 5A, 5B, 5C and 6 may be described with example pseudo codes using a union-find data structure such as that described in Tarjan, Robert E.; van Leeuwen, January (1984), “Worst-case Analysis of Set Union Algorithms”, Journal of the ACM 31 (2): 245-281. The union-find data structure may enable keeping track of a set of records that may be partitioned into a number of disjoint or non-overlapping subsets. For example, the set of records may include the records included in the graphical representation 600. This set of records may be partitioned into disjoint subsets associated with each of the graphical representations 500, 550 and 560. The example pseudo codes may include codes that are used to generate a graphical representation (e.g., Generate Graph), to find a representative record (e.g., Find), and to merge a graphical representation to another graphical representation (e.g., Union). Let X be a graphical representation with an initial rank of zero (0), and Y be another graphical representation. The example pseudo codes may be as follows:

| | |
|---|---|
| function makeGraph (X) | // Generate a graphical representation X |
| X.parent:=X | // Set parent node |
| X.rank:=0 | // Rank is set at zero |
| function Find (X) | // Find the representative record associated with X |
| if X.parent !=X | |

X.parent := find(X.parent)

| | |
|---|---|
| return X.parent | |
| function Union (X,Y) | // Merge two graphical representations X and Y |
| XRoot := find(X) | // Find the root of the first graphical representation X |
| YRoot := find(Y) | // Find the root of the second graphical representation Y |
| if XRoot == YRoot | // If same root, then merge is completed. |

return

// If not same root, merge X and Y.

| | |
|---|---|
| if XRoot.rank < YRoot.rank | // If rank of X is lower than rank of Y, merge X to Y. |

XRoot.parent := YRoot

| | |
|---|---|
| else if XRoot.rank > YRoot.rank | // If rank of X is higher than rank of Y,merge Y to X. |

| YRoot.parent := XRoot | |
|---|---|
| XRoot.rank := XRoot.rank + 1 | // update rank of X |

Path compression may be performed in the function Find(X) allowing any node in the graphical representation to point directly to its representative record, resulting a flatten tree. This is illustrated as the dotted lines in FIG. 6. Further, the merging of two graphical representations is based on merging one at a lower rank to one at a higher rank, as shown in the function Union(X,Y). This is illustrated in FIGS. 4A, 4B and 5A.

The following example pseudo code may be used to generate a graphical representation based on a group of duplicated records where the records are distinct. Let S be a group of records. Let Z be any record in S. The pseudo code may be as follows:

function GenerateGraphFromGroupOfRecords (S)
// Select from S a record to be a representative record
// (or select a record from S to be associated with a root node of the
graphical representation)

{ Z.parent := Z
Z.rank := 1
}

// Associate the remaining records W in S with the representative record Z
// (or connect the nodes associated with the records W to the root node)
where W ≠ Z

{ W.parent := Z
W.rank := 0
}

An example of generating a graphical representation from a group of records is shown with FIG. 4B with the duplicate records D and E.

The following example pseudo code may be used to generate a map M to keep track the graphical representation that a record belongs to. As described above, the content of the map M may be in the form “record: representative record” such as, for example, M={B:A} with B being a record associated with a non-root node of a graphical representation and A being a representative record associated with the root-node of the graphical representation. The map M is initially empty or M={ }. Let S be a group of records.

function CreateAndMergeGroupsOfRecords (S)
If there is no record of S in M:

// Generate graphical representation for from a group of records
{ C ← GenerateGraphFromGroupOfRecords (S)
M ← M ∪ {eᵢ:C.rep} for each eᵢ in S
}

else

{
S1 ← set of records in S but NOT in M
S2 ← set of records in both S and M
C ← GenerateGraphFromGroupOfRecords (S1)
for each eᵢ in S2

```
{ C ← Union(C.rep, M.get(eᵢ))
  update map M with correct graphical representation the
  records belong to
}
```

}

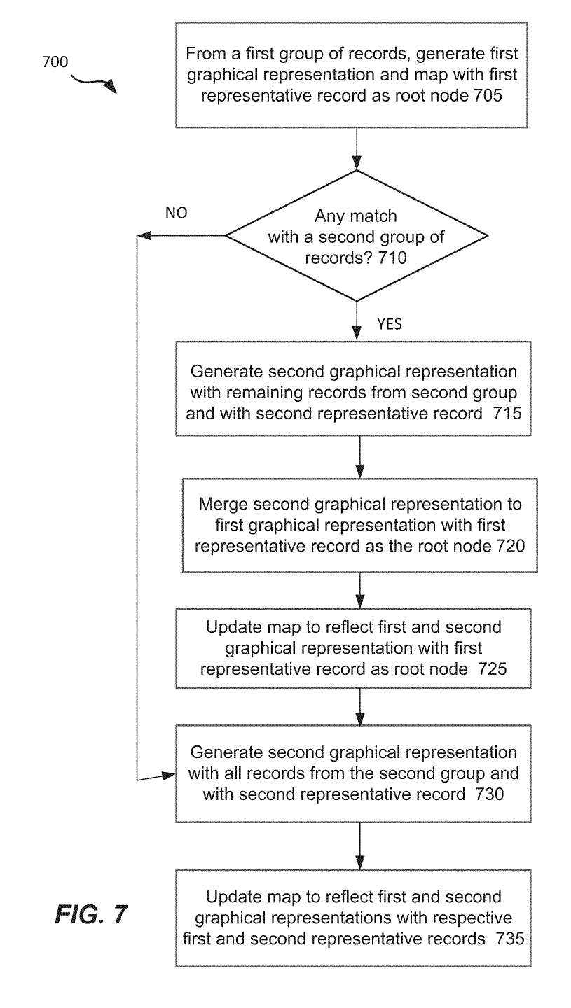

FIG. 7 shows a flowchart of an example process for merging two groups of records using graphical representations, in accordance with some embodiments. The example process 700 may be used to evaluate and merge multiple groups of records based on whether they share any duplicate records. The group of records may be associated with an organization and may need to be incorporated into a CRM database system. The group of records may be generated by a de-duplication process.

The process may start at block 705 where a first group of records may be processed to generate a first graphical representation. A record from the first group may be selected as a first representative record and as a root node of the first graphical representation. The remaining records from the first group are associated with non-root nodes of the first graphical representation. An example is shown in FIG. 4A. A map is also generated to reflect the first graphical representation. Using the example in FIG. 4A, a map M may be defined as M={A:A, B:A, C:A}.

At block 710, a second group of duplicated records may be processed. This may start by first determining whether any of the records in the second group is already in or match with any records in the first group. If there is a match, then the process may flow to block 715 where a second graphical representation may be generated from the remaining records in the second group of records. An example of a second graphical representation is shown in FIG. 4B with the record C being already in the first group, with the remaining records being D and E, and with the record D being the second representative record.

At block 720, the second graphical representation is merged with the first graphical representation with the first representative record remaining as the root node after the merge. The second representative record becomes a non-root node after the merge and assumes the first representative record as its representative record. An example is shown in FIG. 5A where the second representative record D assumes the first representative record A as its representative record after the merge. At block 725, the map M is updated to reflect the merged graphical representations. Using the example in FIG. 5A, the map M may be updated to show that all of the records share the same first representative record A as M={A:A, B:A, C:A, D:A, E:A}.

From block 710, if there is no match, then the process may flow to block 730 where a second graphical representation may be generated from all of the records in the second group of records. An example of a second graphical representation with all of the records is shown in FIG. 5B with the records P, Q and K and with the record P being the second representative record. At block 735, the map M is updated to reflect the merged graphical representations. Using the example in FIGS. 5A and 5B, the map M may be updated to show that all of the records share the same first representative record A as M={A:A, B:A, C:A, D:A, E:A, P:P, Q:P, K:P}.

From block 725 and 735, the flow may continue with another group of records. For example, if there is another group of records, the flow may evaluate that group of records to determine if it has a record that is in another group of records that has already been processed, as is shown in block 710. Although not shown, the process may stop when all of the groups of records have been processed. When completed, the process may yield a map with merged groups of records associated with the same representative record.

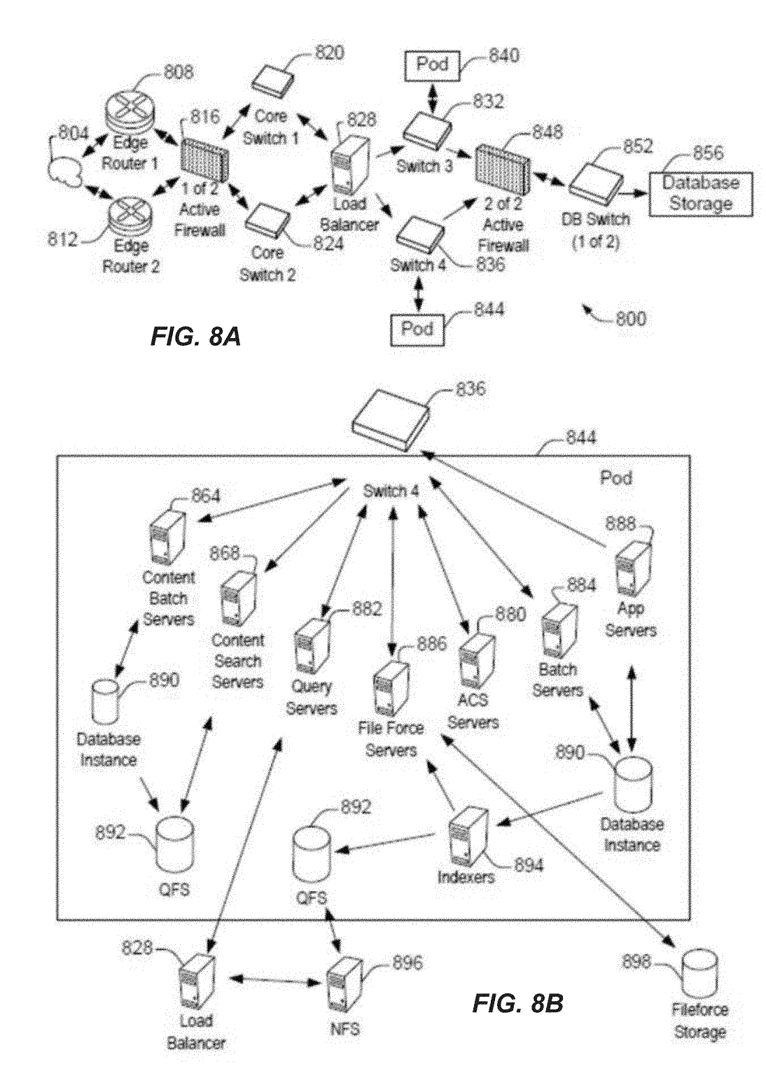

FIG. 8A shows a system diagram 800 illustrating architectural components of an on-demand service environment, in accordance with some embodiments. A client machine located in the cloud 804 (or Internet) may communicate with the on-demand service environment via one or more edge routers 808 and 812. The edge routers may communicate with one or more core switches 820 and 824 via firewall 816. The core switches may communicate with a load balancer 828, which may distribute server load over different pods, such as the pods 840 and 844. The pods 840 and 844, which may each include one or more servers and/or other computing resources, may perform data processing and other operations used to provide on-demand services. Communication with the pods may be conducted via pod switches 832 and 836. Components of the on-demand service environment may communicate with a database storage system 856 via a database firewall 848 and a database switch 852.

As shown in FIGS. 8A and 8B, accessing an on-demand service environment may involve communications transmitted among a variety of different hardware and/or software components. Further, the on-demand service environment 800 is a simplified representation of an actual on-demand service environment. For example, while only one or two devices of each type are shown in FIGS. 8A and 8B, some embodiments of an on-demand service environment may include anywhere from one to many devices of each type. Also, the on-demand service environment need not include each device shown in FIGS. 8A and 8B, or may include additional devices not shown in FIGS. 8A and 8B.

Moreover, one or more of the devices in the on-demand service environment 800 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 804 is intended to refer to a data network or plurality of data networks, often including the Internet. Client machines located in the cloud 804 may communicate with the on-demand service environment to access services provided by the on-demand service environment. For example, client machines may access the on-demand service environment to retrieve, store, edit, and/or process information.

In some embodiments, the edge routers 808 and 812 route packets between the cloud 804 and other components of the on-demand service environment 800. The edge routers 808 and 812 may employ the Border Gateway Protocol (BGP). The BGP is the core routing protocol of the Internet. The edge routers 808 and 812 may maintain a table of IP networks or ‘prefixes’ which designate network reachability among autonomous systems on the Internet.

In one or more embodiments, the firewall 816 may protect the inner components of the on-demand service environment 800 from Internet traffic. The firewall 816 may block, permit, or deny access to the inner components of the on-demand service environment 800 based upon a set of rules and other criteria. The firewall 816 may act as one or more of a packet filter, an application gateway, a stateful filter, a proxy server, or any other type of firewall.

In some embodiments, the core switches 820 and 824 are high-capacity switches that transfer packets within the on-demand service environment 800. The core switches 820 and 824 may be configured as network bridges that quickly route data between different components within the on-demand service environment. In some embodiments, the use of two or more core switches 820 and 824 may provide redundancy and/or reduced latency.

In some embodiments, the pods 840 and 844 may perform the core data processing and service functions provided by the on-demand service environment. Each pod may include various types of hardware and/or software computing resources. An example of the pod architecture is discussed in greater detail with reference to FIG. 8B.

In some embodiments, communication between the pods 840 and 844 may be conducted via the pod switches 832 and 836. The pod switches 832 and 836 may facilitate communication between the pods 840 and 844 and client machines located in the cloud 804, for example via core switches 820 and 824. Also, the pod switches 832 and 836 may facilitate communication between the pods 840 and 844 and the database storage 856.

In some embodiments, the load balancer 828 may distribute workload between the pods 840 and 844. Balancing the on-demand service requests between the pods may assist in improving the use of resources, increasing throughput, reducing response times, and/or reducing overhead. The load balancer 828 may include multilayer switches to analyze and forward traffic.

In some embodiments, access to the database storage 856 may be guarded by a database firewall 848. The database firewall 848 may act as a computer application firewall operating at the database application layer of a protocol stack. The database firewall 848 may protect the database storage 856 from application attacks such as structure query language (SQL) injection, database rootkits, and unauthorized information disclosure.

In some embodiments, the database firewall 848 may include a host using one or more forms of reverse proxy services to proxy traffic before passing it to a gateway router. The database firewall 848 may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

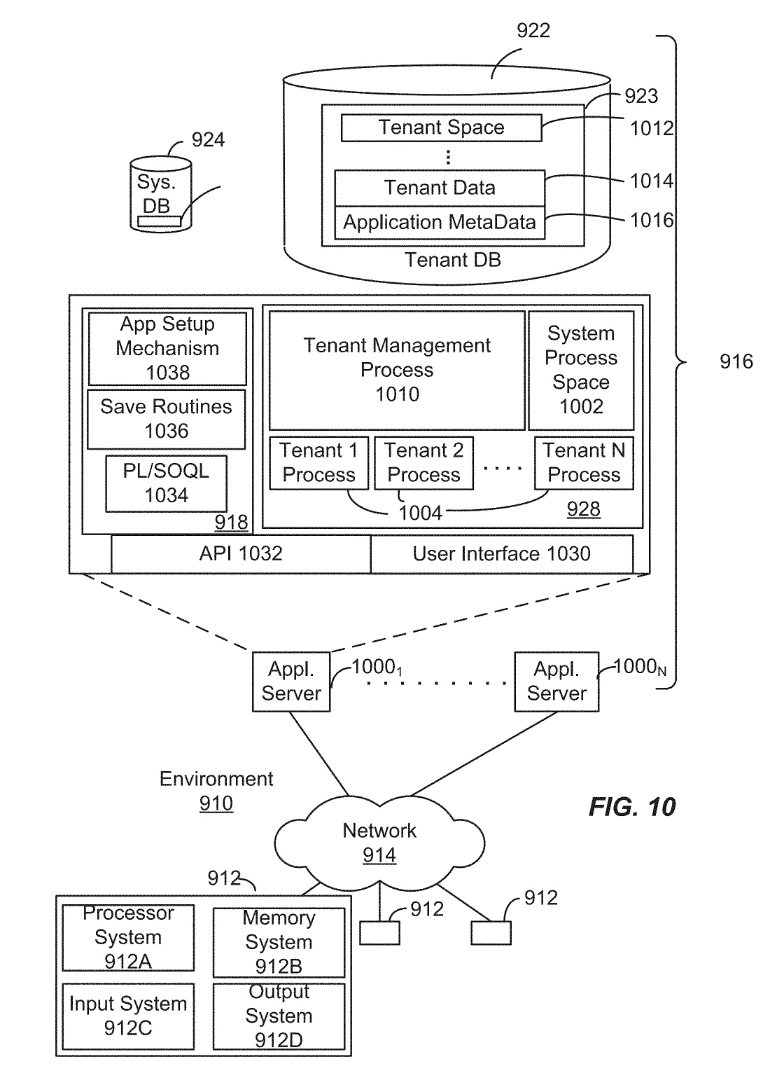

In some embodiments, communication with the database storage system 856 may be conducted via the database switch 852. The multi-tenant database system 856 may include more than one hardware and/or software components for handling database queries. Accordingly, the database switch 852 may direct database queries transmitted by other components of the on-demand service environment (e.g., the pods 840 and 844) to the correct components within the database storage system 856. In some embodiments, the database storage system 856 is an on-demand database system shared by many different organizations. The on-demand database system may employ a multi-tenant approach, a virtualized approach, or any other type of database approach. An on-demand database system is discussed in greater detail with reference to FIGS. 9 and 10.

FIG. 8B shows a system diagram illustrating the architecture of the pod 844, in accordance with one embodiment. The pod 844 may be used to render services to a user of the on-demand service environment 800. In some embodiments, each pod may include a variety of servers and/or other systems. The pod 844 includes one or more content batch servers 864, content search servers 868, query servers 872, file force servers 876, access control system (ACS) servers 880, batch servers 884, and app servers 888. Also, the pod 844 includes database instances 890, quick file systems (QFS) 892, and indexers 894. In one or more embodiments, some or all communication between the servers in the pod 844 may be transmitted via the switch 836.

In some embodiments, the application servers 888 may include a hardware and/or software framework dedicated to the execution of procedures (e.g., programs, routines, scripts) for supporting the construction of applications provided by the on-demand service environment 800 via the pod 844. Some such procedures may include operations for providing the services described herein. The content batch servers 864 may requests internal to the pod. These requests may be long-running and/or not tied to a particular customer. For example, the content batch servers 864 may handle requests related to log mining, cleanup work, and maintenance tasks.

The content search servers 868 may provide query and indexer functions. For example, the functions provided by the content search servers 868 may allow users to search through content stored in the on-demand service environment. The Fileforce servers 876 may manage requests information stored in the Fileforce storage 878. The Fileforce storage 878 may store information such as documents, images, and basic large objects (BLOBs). By managing requests for information using the Fileforce servers 876, the image footprint on the database may be reduced.

The query servers 872 may be used to retrieve information from one or more file systems. For example, the query system 872 may receive requests for information from the app servers 888 and then transmit information queries to the NFS 896 located outside the pod. The pod 844 may share a database instance 890 configured as a multi-tenant environment in which different organizations share access to the same database. Additionally, services rendered by the pod 844 may require various hardware and/or software resources. In some embodiments, the ACS servers 880 may control access to data, hardware resources, or software resources.

In some embodiments, the batch servers 884 may process batch jobs, which are used to run tasks at specified times. Thus, the batch servers 884 may transmit instructions to other servers, such as the app servers 888, to trigger the batch jobs. In some embodiments, the QFS 892 may be an open source file system available from Sun Microsystems® of Santa Clara, Calif. The QFS may serve as a rapid-access file system for storing and accessing information available within the pod 844. The QFS 892 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 868 and/or indexers 894 to identify, retrieve, move, and/or update data stored in the network file systems 896 and/or other storage systems.

In some embodiments, one or more query servers 872 may communicate with the NFS 896 to retrieve and/or update information stored outside of the pod 844. The NFS 896 may allow servers located in the pod 844 to access information to access files over a network in a manner similar to how local storage is accessed. In some embodiments, queries from the query servers 822 may be transmitted to the NFS 896 via the load balancer 820, which may distribute resource requests over various resources available in the on-demand service environment. The NFS 896 may also communicate with the QFS 892 to update the information stored on the NFS 896 and/or to provide information to the QFS 892 for use by servers located within the pod 844.

In some embodiments, the pod may include one or more database instances 890. The database instance 890 may transmit information to the QFS 892. When information is transmitted to the QFS, it may be available for use by servers within the pod 844 without requiring an additional database call. In some embodiments, database information may be transmitted to the indexer 894. Indexer 894 may provide an index of information available in the database 890 and/or QFS 892. The index information may be provided to file force servers 876 and/or the QFS 892.

FIG. 9 shows a block diagram of an environment 910 wherein an on-demand database service might be used, in accordance with some embodiments. Environment 910 includes an on-demand database service 916. User system 912 may be any machine or system that is used by a user to access a database user system. For example, any of user systems 912 can be a handheld computing system, a mobile phone, a laptop computer, a work station, and/or a network of computing systems. As illustrated in FIGS. 9 and 10, user systems 912 might interact via a network 914 with the on-demand database service 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDBMS) or the equivalent may execute storage and retrieval of information against the database object(s). Application platform 918 may be a framework that allows the applications of system 916 to run, such as the hardware and/or software, e.g., the operating system. In an implementation, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

The users of user systems 912 may differ in their respective capacities, and the capacity of a particular user system 912 might be entirely determined by permissions (permission levels) for the current user. For example, where a call center agent is using a particular user system 912 to interact with system 916, the user system 912 has the capacities allotted to that call center agent. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some embodiments are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some embodiments, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some embodiments, system 916, shown in FIG. 9, implements a web-based customer relationship management (CRM) system. For example, in some embodiments, system 916 includes application servers configured to implement and execute CRM software applications as well as provide related data, code, forms, web pages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 916 implements applications other than, or in addition to, a CRM application. For example, system 916 may provide tenant access to multiple hosted (standard and custom) applications. User (or third party developer) applications, which may or may not include CRM, may be supported by the application platform 918, which manages creation, storage of the applications into one or more database objects and executing of the applications in a virtual machine in the process space of the system 916.

Each user system 912 could include a desktop personal computer, workstation, laptop, PDA, cell phone, or any wireless access protocol (WAP) enabled device or any other computing system capable of interfacing directly or indirectly to the Internet or other network connection. User system 912 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914.

Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some embodiments, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

A computer program product implementation includes a machine-readable storage medium (media) having instructions stored thereon/in which can be used to program a computer to perform any of the processes of the embodiments described herein. Computer code for operating and configuring system 916 to intercommunicate and to process web pages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for implementing embodiments can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to some embodiments, each system 916 is configured to provide web pages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also shows a block diagram of environment 910 further illustrating system 916 and various interconnections, in accordance with some embodiments. FIG. 10 shows that user system 912 may include processor system 912A, memory system 912B, input system 912C, and output system 912D. FIG. 10 shows network 914 and system 916. FIG. 10 also shows that system 916 may include tenant data storage 922, tenant data 923, system data storage 924, system data 925, User Interface (UI) 1030, Application Program Interface (API) 1032, PL/SOQL 1034, save routines 1036, application setup mechanism 1038, applications servers 10001-1000N, system process space 1002, tenant process spaces 1004, tenant management process space 1010, tenant storage area 1012, user storage 1014, and application metadata 1016. In other embodiments, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of processors. Memory system 912B may be any combination of one or more memory devices, short term, and/or long term memory. Input system 912C may be any combination of input devices, such as keyboards, mice, trackballs, scanners, cameras, and/or interfaces to networks. Output system 912D may be any combination of output devices, such as monitors, printers, and/or interfaces to networks. As shown by FIG. 10, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to tenant data storage 922 and the tenant data 923 therein, and system data storage 924 and the system data 925 therein to serve requests of user systems 912. The tenant data 923 might be divided into individual tenant storage areas 1012, which can be either a physical arrangement and/or a logical arrangement of data. Within each tenant storage area 1012, user storage 1014 and application metadata 1016 might be similarly allocated for each user. For example, a copy of a user's most recently used (MRU) items might be stored to user storage 1014. Similarly, a copy of MRU items for an entire organization that is a tenant might be stored to tenant storage area 1012. A UI 1030 provides a user interface and an API 1032 provides an application programmer interface to system 916 resident processes to users and/or developers at user systems 912. The tenant data and the system data may be stored in various databases, such as Oracle™ databases.

Application platform 918 includes an application setup mechanism 1038 that supports application developers' creation and management of applications, which may be saved as metadata into tenant data storage 922 by save routines 1036 for execution by subscribers as tenant process spaces 1004 managed by tenant management process 1010 for example. Invocations to such applications may be coded using PL/SOQL 34 that provides a programming language style interface extension to API 1032. A detailed description of some PL/SOQL language embodiments is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 4007, which is hereby incorporated by reference in its entirety and for all purposes. Invocations to applications may be detected by system processes, which manage retrieving application metadata 1016 for the subscriber making the invocation and executing the metadata as an application in a virtual machine.

Each application server 1000 may be communicably coupled to database systems, e.g., having access to system data 925 and tenant data 923, via a different network connection. For example, one application server 10001 might be coupled via the network 914 (e.g., the Internet), another application server 1000N-1 might be coupled via a direct network link, and another application server 1000N might be coupled by yet a different network connection. Transfer Control Protocol and Internet Protocol (TCP/IP) are typical protocols for communicating between application servers 1000 and the database system. However, other transport protocols may be used to optimize the system depending on the network interconnect used.

In certain embodiments, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In some embodiments, therefore, an interface system implementing a load balancing function (e.g., an F5 Big-IP load balancer) is communicably coupled between the application servers 1000 and the user systems 912 to distribute requests to the application servers 1000. In some embodiments, the load balancer uses a least connections algorithm to route user requests to the application servers 1000. Other examples of load balancing algorithms, such as round robin and observed response time, also can be used. For example, in certain embodiments, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each call center agent uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain embodiments, user systems 912 (which may be client machines/systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some embodiments. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some embodiments, for example, all custom entity data rows are stored in a single multi-tenant physical table, which may contain multiple logical tables per organization. In some embodiments, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more embodiments and techniques are described with reference to an implementation in which a service cloud console is implemented in a system having an application server providing a front end for an on-demand database service capable of supporting multiple tenants, the one or more embodiments and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While various embodiments have been described herein, it should be understood that they have been presented by way of example only, and not limitation. Thus, the breadth and scope of the present application should not be limited by any of the embodiments described herein, but should be defined only in accordance with the following and later-submitted claims and their equivalents.

What is claimed is:

1. A computer-implemented method for merging multiple groups of records using graphical representation, the method comprising:
generating, by a database system, a first graphical representation of a first group of records, the first graphical representation including a root node associated with a duplicate record in the first group and identified as a first representative record, the first graphical representation associated with a rank corresponding to a height of the first graphical representation;
forming, by the database system, a map to reflect the first graphical representation including the first representative record;
generating, by the database system, a second graphical representation of a second group of records, the second graphical representation including a root node associated with a duplicate record in the second group and identified as a second representative record;
comparing, by the database system, each of the records in the second group of records with the map to determine if there is a sharing of a duplicate record in the second group of records with the first group of records; and
merging, by the database system, the second graphical representation with the first graphical representation based on the second group of records sharing the duplicate record with the first group of records.

2. The method of claim 1, further comprising updating, by the database system, the map to reflect the merging of the second graphical representation with the first graphical representation.

3. The method of claim 2, wherein the second graphical representation is associated with a non-root node of the first graphical representation.

4. The method of claim 3, further comprising finding, by the database system, the first representative record based on the merging.

5. The method of claim 4, wherein the first representative record, instead of the second representative record, is identified as a representative record of the duplicate records in the second group of records based on the merging.

6. The method of claim 5, wherein the updating the map comprises pairing each of the duplicate records in the first group and in the second group of records with the first representative record.

7. The method of claim 6, further comprising updating, by the database system, the rank of the first graphical representation to reflect a change to the height of the first graphical representation based on the merging.

8. The method of claim 1, further comprising updating, by the database system, the map to reflect the second graphical representation and the first graphical representation based on the second group of records sharing no duplicate record with the first group of records.

9. The method of claim 8, wherein the updating the map comprises pairing each of the duplicate records in the first group with the first representative record and paring each of the duplicate records in the second group of records with the second representative record.

10. An apparatus for identifying duplicate records in a database object, the apparatus comprising:
one or more processors; and
a non-transitory computer readable medium storing a plurality of instructions, which when executed, cause the one or more processors to:
generate a first graphical representation of a first group of records, the first graphical representation including a root node associated with a duplicate record in the first group and identified as a first representative record, the first graphical representation associated with a rank corresponding to a height of the first graphical representation;
form a map to reflect the first graphical representation including the first representative record;
generate a second graphical representation of a second group of records, the second graphical representation including a root node associated with a duplicate record in the second group and identified as a second representative record;
compare each of the duplicate records in the second group of records with the map to determine if there is a sharing of a duplicate record in the second group of records with the first group of records; and
merge the second graphical representation with the first graphical representation based on the second group of records sharing a duplicate record with the first group of records.

11. The apparatus of claim 10, further comprising updating the map to reflect the merging of the second graphical representation with the first graphical representation.

12. The apparatus of claim 11, wherein the second graphical representation is associated with a non-root node of the first graphical representation based on the merging.

13. The apparatus of claim 12, further comprising finding the first representative record based on the merging, wherein the first representative record, instead of the second representative record, is identified as a representative record of the duplicate records in the second group of records based on the merging.

14. The apparatus of claim 13, further comprising updating the rank of the first graphical representation to reflect a change to the height of the first graphical representation based on the merging, wherein the updating the map comprises pairing each of the duplicate records in the first group and in the second group of records with the first representative record.

15. The apparatus of claim 10, further comprising updating the map to reflect the second graphical representation and the first graphical representation based on the second group of records sharing no duplicate record with the first group of records, wherein the updating the map comprises pairing each of the duplicate records in the first group with the first representative record and paring each of the duplicate records in the second group of records with the second representative record.

16. A computer program product comprising computer-readable program code to be executed by one or more processors when retrieved from a non-transitory computer-readable medium, the program code including instructions to:
generate a first graphical representation of a first group of records, the first graphical representation including a root node associated with a duplicate record in the first group and identified as a first representative record, the first graphical representation associated with a rank corresponding to a height of the first graphical representation;
form a map to reflect the first graphical representation including the first representative record;
generate a second graphical representation of a second group of records, the second graphical representation including a root node associated with a duplicate record in the second group and identified as a second representative record;
compare each of the duplicate records in the second group of records with the map to determine if there is a sharing of a duplicate record in the second group of records with the first group of records; and
merge the second graphical representation with the first graphical representation based on the second group of records sharing a duplicated record with the first group of records.

17. The computer program product of claim 16, further comprising:
updating the map to reflect the merging of the second graphical representation with the first graphical representation, wherein the second graphical representation is associated with a non-root node of the first graphical representation.

18. The computer program product of claim 17, further comprising:
finding the first representative record based on the merging, wherein the first representative record, instead of the second representative record, is identified as a representative record of the duplicate records in the second group of records based on the merging; and
updating the rank of the first graphical representation based on the merging, wherein the updating the map comprises pairing each of the duplicate records in the first group and in the second group of records with the first representative record.

19. The computer program product of claim 16, further comprising updating the map to reflect the second graphical representation and the first graphical representation based on the second group of records sharing no duplicate record with the first group of records.

20. The computer program product of claim 19, wherein the updating the map comprises pairing each of the duplicate records in the first group with the first representative record and paring each of the duplicate records in the second group of records with the second representative record.
